(19) United States
(12) Patent Application Publication
(10) Pub. No.: US 2011/0151151 A1
(43) Pub. Date: Jun. 23, 2011

(54) METHOD OF PRODUCING A PRINT MEDIUM

(76) Inventors: Prasad Y. Duggirala, Naperville, IL (US); Timothy S. Keizer, Aurora, IL (US); Jason R. Burney, Aurora, IL (US); Katherine M. Broadus, Aurora, IL (US); Bruce A. Keiser, Plainfield, IL (US)

(21) Appl. No.: 12/646,093

(22) Filed: Dec. 23, 2009

(51) Int. Cl. B41M 5/50; B05D 3/10; B32B 9/04

(52) U.S. Cl. 428/32.34; 427/337; 428/446

(57) ABSTRACT

The present invention relates to a method for producing a print medium with enhanced whiteness and print quality. The method comprises applying a surface treatment composition of a general formula Cₓ(A)_{y}(OH)_{z}(SiO₂)ₖSₘ where C is a cation, A is an anion, and S is a moiety that provides a surface charge selected from surface modifiers, stabilizing agents, and combinations thereof. A facet of the enhanced print quality includes, for example, improved inkjet printing characteristics selected from print density of a printed ink on the print medium, line growth of a printed ink on the print medium, bleed of a printed ink on the print medium, edge roughness of a printed ink on the print medium, mottle of a printed ink on the print medium, wicking of a printed ink on the print medium, show though of a printed ink through the print medium, and any combination of the foregoing.

### TECHNICAL FIELD

This invention relates generally to a method of producing a print medium with enhanced whiteness and print quality. More specifically, the invention relates to applying a surface treatment composition to one or more surfaces of a substrate to produce the print medium. The invention has particular relevance to applying a surface treatment composition comprising a solid particle having a general formula of Cₓ(A)_{y}(OH)_{z}(SiO₂)ₖSₘ that is dispersed in an aqueous medium optionally containing sizing agent(s), starch(es), and/or other additives.

### BACKGROUND

In the paper industry, brightness and whiteness levels continue to trend upward along with demands for improved print quality. These print quality attributes include increased print density, resolution, waterfastness, and reduced dry times. Inkjet is a widely used printing technology in the home and commercial segments. In order to satisfy the demands for stable image quality, the inkjet market has transitioned to pigment-based inks. The clear deficiency of these inks is their performance on uncoated, woodfree sheets. In particular, pigment-based inks produce low print densities and mottle. These characteristics are a consequence of the pigment dispersing throughout the z-direction of the sheet. The problem can be minimized with a treatment to retain the pigment near the surface of the sheet. Any treatment, however, must allow the remainder of the ink composition (water, humectants and surfactants, etc) to pass through the sheet in order to achieve rapid dry times while retaining the pigment at the paper surface. The current industry solution to this problem is the use of divalent metallic salts, such as calcium chloride. The disadvantage of this approach is the gain in print quality is accompanied by a loss of the paper's optical properties (i.e., brightness and whiteness) along with increased machine corrosion.

Improvements in print density and sheet optical properties will result in higher quality printed products. Often, it is difficult to achieve all of the desired attributes concurrently and tradeoffs between these desirable attributes are the common solution encountered. For example, current commercial technology for improved inkjet print density generally results in a loss of optical properties, such as lower sheet brightness and whiteness levels. To counteract these tradeoffs, higher optical brightener dosages are sometimes used which results in higher manufacturing costs.

Prior art suggests the use of Group IIA and IIB metallic salts to improve the print quality of uncoated free sheets. (See U.S. Pat. Nos. 6,207,258 and 7,553,395; U.S. patent application Ser. No. 11/103,827; and U.S. patent application Ser. No. 11/591,087). However, gains in print density using these technologies are typically achieved with penalties in sheet whiteness and shade. Comparative examples of these solutions are provided below. The magnitude of the optical penalties is such that achieving both high levels of print density and sheet brightness and whiteness is challenging.

Corrosion is generally defined as the natural degradation of materials in the environment through electrochemical or chemical reaction. (See Kirk-Othmer Encyclopedia of Chemical Technology, vol. 7, p548 (1993)). With respect to the instant case, corrosion is the degradation of metals used in the papermaking process, which can be uniform or localized. Both are manifested in the papermaking process and are driven by environmental parameters, such as the nature and concentration of ionic species in solution, pH of the solution, temperature, and contact time, to mention a few. Localized corrosion such as pitting or crevice corrosion is an especially insidious form of corrosion. Corrosion typically occurs when three things are present in a system: (i) an aggressive environment, (ii) a cationic and anodic reaction, and (iii) an electron conduction path between the anode and cathode. Environmental aspects that impact corrosion include the presence of halides such as chloride from alkali and alkaline earth metal salts. As explained in Kirk-Othmer (page 559), the degradation of metal when exposed to alkali chlorides increases in the series from LiCl<NaCl<KCl, suggesting that calcium chloride would be more corrosive than magnesium chloride. It is known in the paper industry that deposits form on metal surfaces throughout the papermaking process, and once corrosion starts under a deposit, it may become autocatalytic, increasing the rate of corrosion, and thereby cause severe localized damage to the metal. (See “The Nalco Water Handbook”, Third Edition, McGraw Hill, New York, 2009). Hence, the use of alkali and alkali earth metal chlorides to improve print quality sets the stage for increased corrosion of process equipment as well as storage and makeup tanks.

There thus exists an ongoing need for paper treatments that improve print density and quality without compromising sheet brightness and whiteness, while maintaining lower optical brightener dosages to reduce manufacturing costs. This treatment ideally also would allow for the remainder of the ink composition (water, humectants and surfactants, etc.) to pass through the sheet in order to achieve rapid dry times.

### SUMMARY

This invention accordingly provides a surface treatment composition and method that provides enhanced print quality while simultaneously producing a sheet of paper with improved brightness and whiteness. The disclosed surface treatment composition promotes higher print density with pigment-based inks. A reducing agent and chelant blend may also be incorporated into and/or used in conjunction with the disclosed surface treatment composition to deliver enhanced sheet whiteness and improve the performance of optical brightening agents.

In a preferred aspect, the invention provides methods of producing a print medium with enhanced whiteness and print quality. In a preferred embodiment, the method includes applying a surface treatment composition to one or more surfaces of a substrate, wherein the surface treatment composition comprises a solid particle having a general formula of Cₓ(A)_{y}(OH)_{z}(SiO₂)ₖSₘ that is dispersed in an aqueous medium optionally containing sizing agent(s), starch(es), and/or other additives. In the solid particle, C is a cation; A is an anion; S is a moiety that provides surface charge or surface modification to the dispersed solid particle and is selected from the group consisting of surface modifiers, stabilizing agents, and combinations thereof; and on a molar composition basis subscript x is from 1 to about 10; subscript y is from 1 to about 10; z is from 0 to about 20; k is from 0 to about 32; and m is from 0 to about 100.

In another aspect, the invention provides a print medium prepared according the disclosed method.

It is an advantage of the invention to provide a novel method of treating a surface of a print medium to improve the print quality and simultaneously enhance brightness and whiteness.

It is another advantage of the invention to deliver improved print attributes without a loss in the optical properties of uncoated, woodfree sheets.

It is a further advantage of the invention to deliver a print medium with limited or no whiteness or brightness loss or unfavorable changes in the shade of the medium.

Another advantage of the invention is to make a contribution to sheet brightness due to the inherent brightness of the disclosed composition and thereby deliver a brighter paper.

An additional advantage of the invention is to allow combinations of the disclosed surface treatment composition with optical brightening agents and/or sizing solutions.

It is yet another advantage of the invention to provide a surface treatment composition having decreased corrosivity relative to other commercial offerings.

Additional features and advantages are described herein, and will be apparent from, the following Detailed Description and the Examples.

### DETAILED DESCRIPTION

It has been discovered that print quality on a substrate was improved with the disclosed surface treatment composition. An unexpected and surprising aspect of this discovery was the ability to improve print quality while simultaneously enhancing whiteness and/or brightness. This discovery is particularly advantageous as the invention is relatively less corrosive than conventional commercial offerings. This composition may be applied to any type of printable substrate, such as a print medium comprising printing paper, inkjet printing paper, laser jet paper, copy paper, bond, cut sheet, envelope, photobase paper, inkjet photobase paper, the like, or any combination of the foregoing. The printable substrate may be formed from any suitable material including, for example, virgin pulp, recycled pulp, kraft pulp, sulfite pulp, mechanical pulp, polymeric plastic fibers, any combination of the foregoing pulps, recycled paper, paper tissue, dried paper substrates, and any paper or paper products made from the foregoing, and any combinations of the foregoing.

The present invention relates to aqueous dispersions of solid particle and compositions of such particles, methods of forming such particles, and particular methods of using the particles in a papermaking process to improve print quality without detriment to the whiteness and/or brightness of the substrate. The particulate component of the invention, also generally referred to as a calcium-based particle, can then be combined with additional particles in solution to create the surface treatment composition, and can also be used in conjunction with other compositions and additives, for example, sizing agents and starches.

The invention further relates to an inkjet print medium formed by the disclosed method. In alternative embodiments, the inkjet print medium comprises one or more improved inkjet printing characteristics including, but not limited to, optical density of a printed ink on the print medium; line growth of a printed ink on the print medium; bleed of a printed ink on the print medium; edge roughness of a printed ink on the print medium; mottle of a printed ink on the print medium; wicking of a printed ink on the print medium; show though of a printed ink through the print medium; and any combination of the foregoing.

Additional examples of such compositions (including actives, surface modifiers, etc.) and methods of manufacturing the composition may be found in U.S. patent application Ser. No. 12/546,284, “Calcium-Based Carrier Particles” (reproduced in part herein). According to alternative embodiments, various cations may be used in the particle composition. Representative cation classes include alkali metals, alkaline earth metals, actinides, lanthanide metals, and any combination of the foregoing. Particular cations that may be used include, for example, calcium, magnesium, barium, zinc, the like, and any combination of the foregoing. Although many of the embodiments are herein described with calcium as the cation, it should be appreciated that any combination of the mentioned cations may also be used in those embodiments. In a preferred aspect, the particles are prepared with calcium as the cation, surface modifiers, or other additives or substituents as desired according to certain embodiments as herein described. The particles may be prepared from, for example, a combination of calcium and phosphate containing reactants and/or pre-existing calcium phosphate-based particle sols by further reaction with calcium and phosphate-containing reactants. According to an embodiment, resulting compositions yield solid, suspended solid, or aqueous dispersions of particles, which may contain a stabilizing agent. The composition may also be isolated as, for example, a dry powder.

In one embodiment, the solid particle dispersed in the surface treatment composition has a general formula of Cₓ(A)_{y}(OH)_{z}(SiO₂)ₖSₘ. The variables of the particle are defined as follows: C is a cation; A is an anion; S is a moiety that provides a surface charge and is selected from the group consisting of: surface modifiers, stabilizing agents, and combinations thereof; and on a molar composition basis subscript x is from 1 to about 10; subscript y is from 1 to about 10; z is from 0 to about 20; k is from 0 to about 32; and m is from 0 to about 100.

In a preferred embodiment, C is a calcium cation and A is a phosphate and the composition has a characteristic selected from the group consisting of: a molar ratio of calcium to phosphate from about 0.1 to about 10; a surface area from about 5 m²/g to about 1,000 m²/g; pores ranging in size from about 5 Å to about 120 Å; a total pore volume from about 0.02 cc/g to about 1.0 cc/g; a particle size of about 5 nm to about 10 microns; and any combination of the foregoing.

In another embodiment, the present invention also provides for a solid particle dispersed in a surface treatment composition where the particle comprises a formula of Caₓ(PO₄)_{y}(OH)_{z}Sₘ, wherein x is from 1 to 10, y is from 1 to 10, z is from 0 to 20, m is from 0 to 100, wherein S is a surface modifier or a stabilizing agent or a combination thereof.

In an embodiment, the present invention provides for a composition comprising a formula of Cₓ(A)_{y}(OH)_{z}Sₘ wherein on a molar composition basis x ranges from 1 to 10; y ranges from 1 to 10; z ranges from 0 to 20; and m ranges from 0 to 100; wherein S is a surface modifier or a stabilizing agent or a combination thereof; wherein A is an anion; and wherein C is calcium (e.g., Ca²⁺) or a combination of calcium and other cations. The calcium may be derived from such compounds as, for example, one or more of calcium hydroxide, calcium oxide, and water-soluble calcium salts. Preferred anions include salts of phosphate, hydrogen phosphate, pyrophosphate, carbonate, the like, and any combination of the foregoing. In another embodiment, C is calcium and a combination of cations selected from the group consisting of at least one of the following: alkali metals, alkaline earth metals, actinide and lanthanide metals.

Various components may also be formulated with the aqueous composition containing the dispersed calcium phosphate particle. One of ordinary skill in the art could envision many different types of dispersed particles for delivery; specifically, for example, the type of components chosen by one of ordinary skill in the art is hinged to a desired function. For this invention, the desired function is to improve the print density of inkjet printing without a loss in sheet whiteness caused by an interference with optical brightening agents. In addition to these and other components, a surface modifier or stabilizing agent may also be included.

In an embodiment, surface modifier(s) or stabilizing agent(s) (S of the general formula) are selected from the group consisting of at least one of the following: functional agents, markers, amines, thiols, epoxies, organosilicones, organosilanes, water soluble agents, and any reaction product of the foregoing. In a preferred embodiment, the active is selected from the group consisting of functional agents; markers; amines; thiols; epoxies; organosilicones; organosilanes; water soluble agents; corrosion inhibitors, reaction products of the foregoing; and any combination of the foregoing.

In a further embodiment, the functional agents may contain one or more functional groups such as but not limited to: alcohols, aldehydes, amines, carboxylic acids, or ketones, and/or combinations thereof.

In a preferred embodiment, surface modifiers or stabilizing agents (S in the general formula) include inorganic modifiers including at least one of the following aluminum, zirconium, titanium, zinc, cerium, boron, lithium, iron, magnesium, and salts of the foregoing; polymeric surface modifiers include at least one of the following: polyamines, polyacrylates, polyethylene glycol, polyethylene oxide, polyethylene imines, poly quaternary amines, polyphosphonates, and polysulfonates; organic surface modifiers include at least one of the following: carboxylic acids, amines, phosphonates, organosilicones, organosilanes, glycols, nonionic surfactants, quaternary amines, amino acids; and any combination of the foregoing. Preferred surface modifiers or stabilizing agents include lysine, glycine, alanine, any derivatives of the foregoing, and any combination of the foregoing. Lysine is the most preferred for improvements in print density. A preferred particle has a ratio of calcium to lysine ranging from about 10:1 to about 1:2, with calcium phosphate (sometimes referred to herein as “CaP”) actives level dispersed in water ranging from about 0.0001% to about 50% (explained further in the below examples).

In a further embodiment, the organic nitrogen-containing compounds usually have a molecular weight below 1,000 and contain up to 25 carbon atoms.

In a further embodiment, the amines contain one or more oxygen-containing substituents such as carboxyl, hydroxyl groups, and/or alkyloxy groups.

In another embodiment, the thiols are represented generally by the class of organic and inorganic compounds containing the thiol group having the general formula —B—(SH). Wherein B is a linear or branched group consisting of carbon atoms from 1 to 15 such as —(CH₂)n- where n is 1 to 15, and in particular 1 to 6, and most particularly, 3. Examples of other sulfur-containing compounds useful herein would include but are not limited to trimercapto-s-triazine and thiocarbamates.

In another embodiment, the water-soluble agents of the present invention can be described as organic polymers having a molecular weight of from 100 to 1,000,000 containing functionalities such as amines, carboxylic acids, phosphonates, sulfonates or combinations thereof. Examples of water-soluble agents include but are not limited to polyamines, polyamines, polyacrylic acids, citric acid, and amino acids. The reaction products of silanes and other additives are also anticipated herein with an example of this type of material, but not meant as a limitation being the reaction product between aminopropylsilane and fluorescein isothiocyanate.

In another embodiment, biocides and biocide-containing compositions targeting bacteria, mold, and fungi may also be included in the surface treatment composition and/or used in conjunction with the composition. For purposes of this disclosure, the term “biocide” includes any agent capable of controlling, reducing, inhibiting, or otherwise altering the growth pattern of bacteria, mold, fungi, the like, and combinations thereof. In a further embodiment, the invention is used in conjunction with a method of monitoring bioactivity or presence of biological organisms.

In a further embodiment, the biocides are selected from the group consisting of at least one of the following: phenolics; chlorine containing and/or bromine containing oxidizing compounds; organometallics; organosulfur compounds; heterocyclics; and nitrogen-containing compounds.

In a further embodiment, the biocides are selected from the group consisting of at least one of the following: benzalkonium chlorides; dialkyldimethyl-ammonium chloride; trichloroisocyanurate; copper quinolinolate; methylenebisthiocyanate; zinc dimethyldithiocarbamate; and 2-(n-octyl)-4-isothiazolin-3-one.

In another embodiment, corrosion inhibitors or corrosion inhibitor-containing compositions may be included in the surface treatment composition and/or used in conjunction with the composition. Representative corrosion inhibitors are selected from the group consisting of at least one of the following: chromates; molybdates; tungstates; oxygen scavengers; aliphatic organic amines; the like; and combinations of the foregoing.

In another embodiment, the surface treatment composition may include scale inhibitors and/or may be used in conjunction with scale inhibitor-containing compositions. Representative scale inhibitors are selected from the group consisting of at least one of the following: inorganic pyrophosphate; esters of polyphosphoric acid; esters of phosphonates; organic polymers such as polymers or copolymers of acrylic or methacrylic acid; the like; and any combination of the foregoing.

The molar ratios or amount of each constituent of the surface treatment composition can vary depending on the function to be performed. One of ordinary skill in the art could alter the molar ratios of each constituent so that a particular result can be achieved and can be done so without undue experimentation.

In one embodiment, the calcium to phosphate molar ratio is from 0.1 to 5.

In another embodiment, the content of hydroxide, z in formula, is from 0 to 20.

In another embodiment, the calcium phosphate is from 0.5 to 50 weight percent in the surface treatment composition.

In an embodiment, the surface treatment composition comprises from 0.5% to 50% by weight Ca₁₀(PO₄)₆. In another embodiment, the surface modifier or stabilizing agent is present within the particle in an amount from about 0.0001 wt % to about 80 wt %, based on the total weight of the particle. In a further embodiment, the surface modifier or stabilizing agent is present within the particle in an amount from about 0.5 wt % to about 50 wt %, based on the total weight of the particle.

The particle size of the particle can vary, and similar to other aspects of the particle, the size can vary depending on various factors such as the function and/or application for the surface treatment composition. In one embodiment, the particle has a surface area that ranges from about 5 m²/g to about 1,000 m²/g. In another embodiment, the particle has pores in the range from about 5 Å to about 120 Å. In a further embodiment, the particle has a total pore volume from about 0.02 cc/g to about 1.0 cc/g. In another embodiment, the particle has a size that ranges from about 5 nm and about 10 microns. In another embodiment, the particle has a size ranging from about 10 nm to about 200 nm. In another embodiment, the particle has a size of about 80 nm.

In another embodiment, the particles in the surface treatment composition have diameters ranging from 3 nm to 10 microns and comprise from 0.5% to 50% by weight calcium phosphate and 0.02% to 50% by weight surface modifier or stabilizing agent. In a further embodiment, the particles have a surface area ranging from 5 m²/g and 1,000 m²/g, and a more specifically from 20 and 900 m²/g. In a further embodiment, the particle size is from 5 nm to 5 microns, and more particularly 10 nm to 2 microns. Preferably, the particles are about 80 nm. Further, the particles can be characterized by having an anionic, cationic or neutral surface charge dependent upon the surface modifier selected or the stabilizing agent or a combination thereof. In a further embodiment, the physical form of the particles may be crystalline, amorphous or a combination thereof. In a further embodiment, the base material of the particles, for example, can be derived from soluble calcium and phosphate containing salts, hydroxyapitite, and combinations thereof. In a further embodiment, the particles are dispersed in an aqueous medium optionally containing sizing agent(s), starch(es), and/or other additives.

The particles can be in various chemical states that facilitate application for its intended purpose and/or synthesis of the particles. In one embodiment, the surface treatment composition is an aqueous dispersion of the particles and has a pH selected from the group consisting of: from 5 to 12; from 6.5 to 10; and 8. In an alternative embodiment, the surface treatment composition is an aqueous dispersion of particles and may also contain other cations, such as M₂O, where M is alkali metal (e.g. Li, Na, K, etc.) and/or ammonium. These other cations may be present from trace amounts to up to about 30% by weight. In another embodiment of this invention, the pH of the dispersion is from 5 to 12, and preferably from 7 to 9. The particles of this invention can further have positive, negative, or neutral charge.

In another embodiment, the surface treatment composition is a dispersion, specifically, an aqueous dispersion of the particles of the invention. In an embodiment, the particle dimension is less than about 10 microns, more preferably a dimension less than 1 micron, and most preferably one dimension in the colloidal range of less than 200 nm. In a further embodiment, the dispersions have a calcium phosphate content of at least about 0.5% by weight, but it is more suitable that the calcium content is within the range of from about 1% to 50% by weight, preferably from about 1% to 40% by weight, and more preferably from about 1% to 30% by weight.

In another embodiment, the particle is a sol, specifically, the particles have an average particle size below about 200 nm and preferably in the range of from about 3 to about 150 nm, more specifically, 5 and 100 nm, and more specifically, 20 and 100 nm. In a further embodiment, the particle size refers to the average size of the primary particles, which may be aggregated or non-aggregated. In yet a further embodiment, the specific surface area of the particles is suitably at least 5 m²/g calcium and preferably at least between 100 m²/g and 1,000 m²/g. Generally, the specific surface area can be up to about 1,000 m²/g.

The particles may also contain (e.g., be functionalized with) one or more stabilizing agents and/or surface modifiers. In one aspect, stabilizing agents are materials that are capable of bringing fine solid particles into a state of, for example, suspension or dispersion, as to inhibit or prevent their agglomerating or settling in a fluid medium.

In one embodiment, the stabilizing agents and/or surface modifiers are selected from the group consisting of at least one of the following: organic phosphonates; polyacrylates and copolymers with compatible monomers; sulfonated polymers; polymaleates; and certain natural polymers such as tannins and lignins. These materials are available from several manufacturers under several trademarks. Some examples are Goodrite® polyacrylates and copolymers supplied by Goodrich Chemical Company, Dequest® organic phosphonates supplied by Monsanto Chemical Company, and Versa-TL® polysulfonates supplied by National Starch Corporation, to name a few (trademarks are the property of their respective owners).

The amount of stabilizing agent and/or surface modifier in the disclosed particles vary and depend upon many factors that would be apparent to one of ordinary skill in the art. In a preferred embodiment, the stabilizing agent is present from about 0.0001 to about 50 weight percent, based on total particle weight.

In another embodiment, the surface treatment composition further comprises starch or starch applied separately from the surface treatment composition to the substrate. Representative starches include natural starches or chemically-modified starches. Such starches included, for example, amylase, amylopectin, starches containing various amounts of amylose and amylopectin, corn starch, potato starch, enzymatically treated starches, hydrolyzed starches, heated starches, cationic starches, anionic starches, ampholytic starches, cellulose and cellulose derived compounds, and any combination of the foregoing. Chemically-modified starches may further include, for example, those modified with hydroxyethyl and/or hydroxypropyl groups as well as anionic and/or cationic groups.

In another embodiment, the invention further comprises applying at least one optical brightening agent, either as part of the surface treatment composition or as a separate composition. “Optical brighteners” are fluorescent dyes or pigments that absorb ultraviolet radiation and reemit it at a higher frequency in the visible spectrum (blue), thereby effecting a white, bright appearance to the paper sheet when added to the stock furnish. Representative optical brighteners include, but are not limited to azoles, biphenyls, coumarins; furans; ionic brighteners, including anionic, cationic, and anionic (neutral) compounds, such as the Eccobrite® and Eccowhite® compounds available from Eastern Color & Chemical Co. (Providence, R.I.); naphthalimides; pyrazenes; substituted (e.g., sulfonated) stilbenes, such as the Leucophor® range of optical brighteners available from the Clariant Corporation (Muttenz, Switzerland), and Tinopal® from Ciba Specialty Chemicals (Basel, Switzerland); salts of such compounds including but not limited to alkali metal salts, alkaline earth metal salts, transition metal salts, organic salts and ammonium salts of such brightening agents; and combinations of one or more of the foregoing agents (trademarks are the property of their respective owners). Optical brightening agents may also be dilsulfonated, tetrasulfonated, or hexasulfonated stilbene derivatives; and any combination of the foregoing. Additional representative optical brightening agents include azoles; biphenyls; coumarins; furans; naphthalimides; pyrazenes; substituted stilbenes; salts of the foregoing, including alkali metal salts, alkaline earth metal salts, transition metal salts, organic salts, and ammonium salts; and any combination of the foregoing.

In an additional embodiment, the surface treatment composition of the invention further comprises one or more brightness-preserving and brightness-enhancing components. In an embodiment, the component(s) preserves and enhances the brightness of lignocellulosic materials. In another embodiment, the brightness-preserving and brightness-enhancing component(s) comprises at least one penetrant, at least one reductive nucleophile, and/or at least one chelant applied either simultaneously with or separately from the surface treatment composition of the invention. Such formulations are disclosed in U.S. patent application Ser. Nos. 11/387,499, “Improved Compositions and Processes for Paper Production” and 11/490,738, “Improved Compositions and Processes for Paper Production,” both currently pending.

Representative reductive nucleophiles include sulfites; bisulfites; metabisulfites (pyrosulfites); sulfoxylates; thiosulfates; dithionites (hydrosulfites); polythionates; formamidinesulfinic acid and salts and derivatives thereof; formaldehyde bisulfite adduct and other aldehyde bisulfite adducts; sulfinamides and ethers of sulfmic acid; sulfenamides and ethers of sulfenic acid; sulfamides; phosphines; phosphonium salts; phosphites; thiophosphites; water-soluble inorganic sulfites; substituted phosphines and tertiary salts thereof; formamidine acid and salts thereof; formaldehyde bisulfite adducts; the like; and any combination of the foregoing.

Representative chelants include organic phosphonates phosphates, carboxylates, dithiocarbamates, salts of the foregoing, the like, and any combination of the foregoing. “Organic phosphonates” means organic derivatives of phosphonic acid, HP(O)(OH)₂, containing a single C—P bond, such as HEDP(CH₃C(OH)(P(O)(OH)₂), 1-hydroxy-1,3-propanediylbis-phosphonic acid ((HO)₂P(O)CH(OH)CH₂CH₂P(O)(OH)₂)); preferably containing a single C—N bond adjacent (vicinal) to the C—P bond, such as DTMPA ((HO)₂P(O)CH₂N[CH₂CH₂N(CH₂P(O)(OH)₂)₂]₂), AMP(N(CH₂P(O)(OH)₂)₃), PAPEMP ((HO)₂P(O)CH₂)₂NCH(CH₃)CH₂(OCH₂CH(CH₃))₂N(CH₂)₆N(CH₂P(O)(OH)₂)₂), HMDTMP ((HO)₂P(O)CH₂)₂N(CH₂)₆N(CH₂P(O)(OH)₂)₂), HEBMP(N(CH₂P(O)(OH)₂)₂CH₂CH₂OH), the like, and combinations thereof “Organic phosphates” means organic derivatives of phosphorous acid, P(O)(OH)₃, containing a single C—P bond, including triethanolamine tri(phosphate ester) (N(CH₂CH₂OP(O)(OH)₂)₃), the like, and combinations thereof. “Carboxylic acids” means organic compounds containing one or more carboxylic group(s), —C(O)OH, preferably aminocarboxylic acids containing a single C—N bond adjacent (vicinal) to the C—CO₂H bond, such as EDTA ((HO₂CCH₂)₂NCH₂CH₂N(CH₂CO₂H)₂), DTPA ((HO₂CCH₂)₂NCH₂CH₂N(CH₂CO₂H)CH₂CH₂N(CH₂CO₂H)₂), and the like and alkaline and alkaline earth metal salts thereof, and combinations thereof “Dithiocarbamates” include monomeric dithiocarbamates, polymeric dithiocarbamates, polydiallylamine dithiocarbamates, 2,4,6-trimercapto-1,3,5-triazine, disodium ethylenebisdithiocarbamate, disodium dimethyldithiocarbamate, the like, and combinations thereof.

In an embodiment, the chelant is selected from the group consisting of diethylene-triamine-pentamethylene phosphonic acid (DTMPA) and salts thereof, diethylenetriaminepentaacetic acid (DTPA) and salts thereof, and ethylenediaminetetraacetic acid (EDTA) and salts thereof, and combinations thereof.

In an embodiment of this invention, the surface treatment composition may also comprise a surface sizing agent or a combination of different surface sizing agents. Surface sizing agents are well known in the art. U.S. Pat. No. 6,426,381, “Fine-Particle Polymer Dispersions for Paper Sizing,” discloses a sizing agent that is an aqueous dispersion obtainable by free radical emulsion copolymerization of ethylenically unsaturated monomers in the presence or absence of starch. Other representative sizing agents include polymers or copolymers of styrene acrylate or styrene acrylate maleic anhydride. It should be appreciated that any suitable sizing agent may be used mixed within or in conjunction with the surface treatment composition of the invention.

In an embodiment, the surface treatment composition may also contain other additives. Representative additives include poly vinyl alcohol, pigments, defoamers, lubricants, surfactants, dispersants, rheology modifiers, dyes, the like, and any combination of the foregoing.

The surface treatment composition herein disclosed may be applied to the surface of a substrate by any suitable means known in the art. In an embodiment, the surface treatment composition is spray-coated onto one or more surfaces of the substrate. In a preferred embodiment, the surface treatment composition is mixed with a surface sizing solution to form a mixture and the mixture is applied to one or more surfaces of the substrate in a size press. In another embodiment, the field application point is addition to cooked size press starch, where the disclosed particles and other components can also serve to dilute the starch in the run tank. The targeted dosage is preferably between about 1 an about 20 lbs active per ton of paper, more preferably from about 3 to about 10 lbs active particle per ton or paper, and most preferably between about 5 and 7 lbs active particle per ton of paper. The target dosages are based on total solids dry weight of the paper.

The foregoing may be better understood by reference to the following examples, which are intended for illustrative purposes and are not intended to limit the scope of the invention.

In general, the chemicals used in the examples below are readily available from various laboratory supply houses throughout the world (e.g., Sigma-Aldrich Corporation, St. Louis, Mo. USA). In particular, the following special chemicals were obtained from sources as indicated. The L-lysine was obtained from EMD Biosciences, 480 South Democrat Road, Gibbstown, N.J., 08027 USA as Catalogue Number 4400; DL-lysine was obtained from either Sigma-Aldrich Corporation, St. Louis, Mo. USA as Catalogue Number 260681 or USB Corporation, 26111 Miles Road, Cleveland, Ohio. 44128, USA as Catalogue Number 18580; Betaine was obtained from Alfa Aesar, 26 Parkridge Road, Ward Hill, Mass., 01835 USA as Catalogue Number A16122; and ethoxolated corn starch is obtained from Penford Products, Co. First Street S.W., Cedar Rapids, Iowa 52404, USA as Penford® Gum PG280 (starch solution was prepared according to the recommendations of the supplier).

### Example 1

This Example illustrates the synthesis of lysine-functionalized calcium phosphate particles having a 1:1 calcium to lysine ratio. A 3% by weight lysine-functionalized calcium phosphate particle dispersion was prepared using a mixing chamber (e.g., as disclosed in U.S. patent Ser. No. 11/339,169, “Method and Arrangement for Feeding Chemicals into a Process Stream,”). To a beaker were added 300.15 g of L-lysine monohydrochloride, 241.60 g of CaCl₂.2H₂O, 287.85 g of 10% NaOH, and 1,213.65 g of deionized water. To another beaker were added 72.50 g of (NH₄)₂HPO₄, and 1884.7 g of deionized water. The solutions were co-fed into the mixing chamber at pump speeds of 3,400 rpm. A white slurry was collected from the exit port. Overnight, the solids dispersed and produced a white cloudy dispersion. The average particle size by DLS was 73 nm.

### Example 2

This Example illustrates the synthesis of lysine-functionalized calcium phosphate particles having a 1:1 calcium to lysine ratio. A 2% by weight lysine-functionalized calcium phosphate particle dispersion was prepared under high shear conditions. To a beaker were added 182.69 g of L-lysine monohydrochloride, 147.41 g of CaCl₂.2H₂O, 34.84 g of 50% NaOH, and 1,468.16 g of deionized water. To another beaker were added 44.36 g of (NH₄)₂HPO₄, and 1,691.84 g of deionized water. The solutions were co-fed into an IKA Ultra Turrax, model no. T-25 Basic (available from IKA® Works, Inc. in Wilmington, N.C.) high shear mixer in which the mixing head had been modified by the addition of an extra inlet port (referred to below as “modified IKA high shear”) at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 91 nm.

### Example 3

This Example illustrates the synthesis of lysine-functionalized calcium phosphate particles having a 1:1 calcium to lysine ratio. A 4% by weight lysine-functionalized calcium phosphate particle dispersion was prepared under high shear conditions. To a beaker were added 182.60 g of L-lysine monohydrochloride, 147.04 g of CaCl₂.2H₂O, 34.84 g of 50% NaOH, and 573.32 g of deionized water. To another beaker were added 43.77 g of (NH₄)₂HPO₄, and 804.06 g of deionized water. The solutions were co-fed into a modified IKA high shear mixer at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 80 nm.

### Example 4

This Example illustrates the synthesis of a lysine-functionalized calcium phosphate particle having a 1:1 calcium to lysine ratio. A 4% by weight lysine-functionalized calcium phosphate particle dispersion was prepared under high shear conditions. To a beaker were added 183.02 g of L-lysine monohydrochloride, 147.03 g of CaCl₂.2H₂O, 34.84 g of 50% NaOH, and 876.36 g of deionized water. To another beaker were added 43.72 g of (NH₄)₂HPO₄, and 1095.8 g of deionized water. The solutions were co-fed into a modified IKA high shear mixer at pump speeds of 1,580 rpm for the calcium solution and 1800 rpm for the phosphate solution. A white slurry was collected from the exit port. Overnight, the solids dispersed and produced a white cloudy dispersion. The average particle size by DLS was 55 nm.

### Example 5

This Example illustrates the synthesis of a lysine-functionalized calcium phosphate particle having a a 1:1 calcium to lysine ratio. A 1% by weight lysine-functionalized calcium phosphate particle dispersion was prepared under high shear conditions. To a beaker were added 45.59 g of L-lysine monohydrochloride, 36.96 g of CaCl₂.2H₂O, 9.00 g of 50% NaOH, and 812.10 g of deionized water. To another beaker were added 11.21 g of (NH₄)₂HPO₄, and 870.16 g of deionized water. The solutions were co-fed into a modified IKA high shear mixer at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 111 nm.

### Example 6

This Example illustrates the synthesis of a lysine-functionalized calcium phosphate particle having a 1:0.5 calcium to lysine ratio. A 1% by weight lysine-functionalized calcium phosphate particle dispersion was prepare under high shear conditions. To a beaker were added 45.69 g of L-lysine monohydrochloride, 74.00 g of CaCl₂.2H₂O, 17.40 g of 50% NaOH, and 1,409.22 g of deionized water. To another beaker were added 22.03 g of (NH₄)₂HPO₄, and 1,494.77 g of deionized water. The solutions were co-fed into a modified IKA high shear mixer at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 270

### Example 7

This Example illustrates the synthesis of a lysine-functionalized calcium phosphate particle having a 1:0.75 calcium to lysine ratio. A 3% by weight lysine-functionalized calcium phosphate particle dispersion was prepared under high shear conditions. To a beaker were added 100.27 g of L-lysine monohydrochloride, 107.42 g of CaCl₂.2H₂O, 19.00 g of 50% NaOH, and 684.41 g of deionized water. To another beaker were added 32.28 g of (NH₄)₂HPO₄, and 810.97 g of deionized water. The solutions were co-fed into a modified IKA high shear mixer at pump speeds of 1,580 rpm for the calcium solution and 1,800 rpm for the phosphate solution. A white slurry was collected from the exit port. Overnight the solids dispersed and produced a white cloudy dispersion. The average particle size by DLS was 48 nm.

### Example 8

This Example illustrates the synthesis of a lysine-functionalized calcium phosphate particle having a 1:0.75 calcium to lysine ratio. A 1% by weight lysine-functionalized calcium phosphate particle dispersion was prepared in a mixing chamber. To a beaker were added 60.38 g of L-lysine monohydrochloride, 64.42 g of CaCl₂.2H₂O, 11.40 g of 50% NaOH, and 1,458.40 g of deionized water. To another beaker were added 1934 g of (NH₄)₂HPO₄, and 1,528.00 g of deionized water. The solutions were co-fed into the mixing chamber at pump speeds of 3,600 rpm. A white slurry was collected from the exit port. Overnight the solids dispersed and produced a white cloudy dispersion. The average particle size by DLS was 64 nm.

### Example 9

This Example illustrates the synthesis of a lysine-functionalized calcium phosphate particle having a 1:0.5 calcium to lysine ratio. A 3% by weight lysine-functionalized calcium phosphate particle dispersion was prepared in a mixing chamber. To a beaker were added 150.00 g of L-lysine monohydrochloride, 2, 41.17 g of CaCl₂.2H₂O, 30.30 g of 10% NaOH, and 1,606.03 g of deionized water. To another beaker were added 72.61 g of (NH₄)₂HPO₄, and 1,818.41 g of deionized water. The solutions were co-fed into the mixing chamber at pump speeds of 3,400 rpm. A white slurry was collected from the exit port. Overnight, the solids dispersed and produced a white cloudy dispersion. The average particle size by DLS was 124 nm.

### Example 10

This Example illustrates the synthesis of a calcium phosphate particle in the absence of a moiety that provides a surface a charge. A calcium phosphate particle dispersion was prepared in a mixing chamber. To a beaker were added 200.09 g of CaCl₂.2H₂O, and 1470.61 g of deionized water. To another beaker were added 59.92 g of (NH₄)₂HPO₄, 15.03 g of 50% NaOH and 1497.78 g of deionized water. The solutions were co-fed into the mixing chamber at pump speeds of 3,400 rpm. A white slurry was collected from the exit port. The average particle size by DLS was greater than 6,000 nm.

### Example 11

This Example illustrates the preparation of a glycine-functionalized calcium phosphate particle at a 1:2 calcium to glycine ratio. A 2.9% by weight glycine-functionalized calcium phosphate particle dispersion was prepared via a batch synthesis method. To a beaker were added 7.54 g of DL-glycine and 50 mL of 1M CaCl₂, and the mixture was stirred to dissolve the glycine. Once the glycine was dissolved, 50 mL of 0.33M (NH₄)₂HPO₄ was added with stirring, precipitating a white solid. The pH of the solution was raised to 9.07 with concentrated NH₄OH. The reaction mix was stirred for two hours and then poured into a bottle. The average particle size by DLS was 3,070 nm.

### Example 12

This Example illustrates the preparation of a alanine-functionalized calcium phosphate particle at a 1:2 calcium to alanine ratio. A 2.8% by weight alanine-functionalized calcium phosphate particle dispersion was prepared via a batch synthesis method. To a beaker were added 8.93 g of DL-alanine, 50 mL of 1M CaCl₂, and 0.5 mL of concentrated NH₄OH, and the mixture was stirred to dissolve the alanine. Once the alanine was dissolved, 50 mL of 0.33M (NH₄)₂HPO₄ was added with stirring, precipitating a white solid. The pH of the solution was raised to 9.11 with concentrated NH₄OH. The reaction mix was stirred for two hours and then poured into a bottle. The average particle size by DLS was 3550 nm.

### Example 13

This Example illustrates the preparation of a lysine-functionalized calcium phosphate particle at a 1:2 calcium to lysine ratio. A 2.75% by weight lysine-functionalized calcium phosphate particle dispersion was prepared via a batch synthesis method. To a beaker were added 18.42 g of DL-lysine monohydrochloride, 50 mL of 1M CaCl₂, and 2 g of 50% NaOH, and the mixture was stirred to dissolve the lysine. Once the lysine was dissolved, 50 mL of 0.33M (NH₄)₂HPO₄ was added with stirring, precipitating a white solid. The pH of the solution was raised to 9.06 with 1 g of 50% NaOH. The reaction mix was stirred for two hours and then poured into a bottle. Overnight the solids dispersed and produced a clear light yellow dispersion. The average particle size by DLS was 53 nm, and the particles had a zeta potential of +40 mV.

### Example 14

This Example illustrates the preparation of a lysine-functionalized calcium phosphate particle having a 1:1.32 calcium to lysine ratio. A 2.9% by weight lysine-functionalized calcium phosphate particle dispersion was prepared via a batch synthesis method. To a beaker were added 12.18 g of DL-lysine monohydrochloride, 50 mL of 1M CaCl₂, and 1.5 g of 50% NaOH, and the mixture was stirred to dissolve the lysine. Once the lysine was dissolved, 50 mL of 0.33M (NH₄)₂HPO₄ was added with stirring, precipitating a white solid. The pH of the solution was raised to 9.06 with 0.8 g of 50% NaOH. The reaction mix was stirred for two hours and then poured into a bottle. Overnight the solids dispersed and produced a clear light yellow dispersion. The average particle size by DLS was 80 nm.

### Example 15

This Example illustrates the preparation of a lysine-functionalized calcium phosphate particle having a 1:1 calcium to lysine ratio. A 3% by weight lysine-functionalized calcium phosphate particle dispersion was prepared via a batch synthesis method. To a beaker were added 9.13 g of DL-lysine monohydrochloride, 50 mL of 1M CaCl₂, and 1 g of 50% NaOH, and the mixture was stirred to dissolve the lysine. Once the lysine was dissolved 50 mL of 0.33M (NH₄)₂HPO₄ was added with stirring, precipitating a white solid. The pH of the solution was raised to 9.06 with 0.75 g of 50% NaOH. The reaction mix was stirred for two hours and then poured into a bottle. Overnight the solids dispersed and produced a clear light yellow dispersion. The average particle size by DLS was 90 nm.

### Example 16

This Example illustrates the preparation of a phosphinocholine-functionalized calcium phosphate particle having a 1:1 calcium to phosphinocholine ratio. A 1.6% by weight phosphinocholine-functionalized calcium phosphate particle dispersion was prepared via a batch synthesis method. To a beaker were added 5.20 g of calcium phosphinocholine chloride and 60 mL of deionized water, and the mixture was stirred to dissolve the solids. Once the solids were dissolved, 20 mL of 0.33 M (NH₄)₂HPO₄ was added with stirring, precipitating a solid. The reaction mix was stirred for 1 hour and then poured into a bottle. Overnight the solids dispersed and produced a clear dispersion. The average particle size by DLS was 115 nm.

### Example 17

This Example illustrates the preparation of an aminoethyl phosphate-functionalized calcium phosphate particle having a 1:2 calcium to aminoethyl phosphate ratio. A 1.4% by weight aminoethyl phosphate-functionalized calcium phosphate particle dispersion was prepared via a batch synthesis method. To a 2-neck round-bottomed flask equipped with a condenser and an air purge were added 3.69 g of aminoethyl phosphate, 50 mL of 1 M Ca(NO₃)₂, and 60 mL of deionized water. The mixture was stirred to dissolve the aminoethyl phosphate. Once all the aminoethyl phosphate was dissolved, the pH of the solution was raised from 3.15 to 8.80 by drop-wise addition on 50% NaOH. 50 mL of 0.33 M (NH₄)₂HPO₄ was then added with stirring, precipitating a white solid. The pH was readjusted to 8.64 with 50% NaOH. The reaction mix was heated to reflux. After 2.5 hours of heating the solids had dispersed and produced a clear colorless dispersion. The solution was cooled to room temperature and poured into a bottle. The average particle size by DLS was 75 nm.

### Example 18

This Example illustrates the preparation of a lysine/betaine-functionalized calcium phosphate particle having a 1:0.5:1.5 calcium to lysine to betaine ratio made under high shear conditions. To a beaker were added 231.18 g of betaine hydrochloride, 91.32 g of DL-lysine monohydrochloride, 143.18 g of CaCl₂.2H₂O, 50 g of 50% NaOH, and 860 g of deionized water. To another beaker were added 43.84 g of (NH₄)₂HPO₄ and 1173.16 g of deionized water. The solutions were co-fed into a modified IKA high shear mixer at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 87 nm.

### Example 19

This Example illustrates the preparation of a lysine-functionalized calcium phosphate particle having a 1:2 calcium to lysine ratio made under high shear conditions. To a beaker were added 365.93 g of DL-lysine monohydrochloride, 143.03 g of CaCl₂.2H₂O, 71.30 g of 50% NaOH, and 968.04 g of deionized water. To another beaker were added 43.89 g of (NH₄)₂HPO₄, and 1,352.31 g of deionized water. The solutions were co-fed into a modified IKA high shear mixer at pump speeds of 1,580 rpm for the calcium solution and 1,800 rpm for the phosphate solution. A white slurry was collected from the exit port. Overnight, the solids dispersed and produced a white cloudy dispersion. The average particle size by DLS was 53 nm.

### Example 20

This Example illustrates preparation of a calcium lysinate solution. To a beaker were added 1.38 g of CaCl₂.2H₂O, 3.87 g of L-lysine monohydrochloride, and 34.75 g of deionized water. The pH of the solution was adjusted to 7.78 with 50% NaOH, and the solution was then diluted to a final mass of 50 g.

### Example 21

This Example illustrates preparation of a dried 1:1 calcium to lysine and a dried 1:0.5 calcium to lysine solids. Solutions were prepared as described in Examples 1 and 9. The solutions were spray dried on a Buchi mini spray dryer B-290 with the following parameters: 180° C. inlet temperature, 80° C. outlet temperature, aspirator at 100%, pump at 35%, and air flow rate at 4 cfm. A dry solid was produced.

### Example 22

Using starch as described above, wood-free, unsized paper samples were coated with starch-based solutions in the laboratory using a technique that simulates a puddle size press operation on a paper machine. Paper sheets were soaked for a fixed time (10 seconds) in starch solutions, and then held in a vertical position for 30 seconds to allow excess starch to drain. The sheet was pressed between two blotter sheets and passed through a rotary drum drier at 200° F. for 1 minute.

The coating solutions were prepared with the following order of addition: cooked ethoxylated corn starch, calcium source (either CaCl₂ or the designated calcium phosphate particle, optical brightening agent (OBA), and Extra White™ NW1 (available from Nalco Company in Naperville, Ill. USA). The OBAs used can be classified as tetrasulfonated derivatives (Tinopal ABP-A) or hexasulfonated derivatives (Tinopal SCP or Blancophor UWS). As an example, the tetrasulfonated OBA is obtainable as KalBrite C Powder from Kalamazoo Paper Chemicals in Richland, Mich. USA), and Tinopal SCP is available from Diakaffil Chemicals Limited in Mumbai, India).

Dosages were based on the oven-dried weight of the base sheet (70 g/m²). OBAs and Extra White NW1 were dosed as received from the supplier. All calcium sources were dosed on an actives basis. A dosage of 0.25% corresponds to 2.5 kg/ton of base sheet paper. The pH of the starch-based solutions was adjusted with a dilute sodium hydroxide solution, such that the final pH was equivalent to the pH of a starch solution containing only OBA.

Black ink test targets were printed with a Hewlett Packard 6122 Deskjet, and color test targets were printed with a Kodak 5100 AIO printer. The resulting print densities were recorded with an X-Rite 500 Series Spectrodensitometer. Unless otherwise noted, the print density data in the examples refers to prints made with the HP6122 Deskjet black ink. Brightness, whiteness, L*, a* and b* values were measured with a Technidyne Color Touch 2 instrument using a D65 light source. All results are based on an average of three coated samples.

“Brightness” is a measurement of the ability of a sample to reflect monochromatic (457 nm) light as compared to a known standard, using magnesium oxide (MgO). Brightness is a term used to describe the whiteness of pulp or paper, on a scale from 0% (absolute black) to 100% (relative to a MgO standard, which has an absolute brightness of about 96%) by the reflectance of blue light (475 nm) from the paper.

“Whiteness” is a measurement of the CIE (Commission of Internationale de l'Eclairage) whiteness of a sample as derived from the CIE tristimulus values, corresponding to the CIE 1964 standard observer and the CIE illuminant D65.

CIE L*, a*, and b* colorimetric values are used to describe the shade of a material in color space. L* is a measure of lightness, and values range from 0 (absolute black) to 100 (absolute white). Positive a* values indicate redness and negative a* values indicate greenness. Positive b* values represent yellowness, and negative b* values represent blueness.

Table 1 shows comparative examples. The results demonstrate micron-sized calcium particles (calcium phosphate and calcium carbonate) do not produce the desired increase in print density of printed images. The source of calcium carbonate was Covercarb HP from Omya, which has a median particle size of 0.7 micron. Table 1 further shows calcium phosphate carrier particles prepared with a polyacrylate dispersant (sample 17) do not improve printed optical density.

TABLE 1

| Example | OBA | Treatment | Whiteness | a* | Print density |
|---|---|---|---|---|---|
| 22 | 1.3% Tinopal SCP | None (reference) | 138.3 | 2.00 | 1.04 |
| 22 | 1.3% Tinopal SCP | 0.7% CaPO₄ (micron size) | 135.5 | 1.95 | 1.01 |
| 22 | 1.3% Tinopal SCP | 0.7% CaPO₄/PAA 1:2 (50 nm) | 139.1 | 2.06 | 1.02 |
| 22 | 0.6% Tinopal SCP | None (reference) | 131.6 | 1.59 | 1.05 |
| 22 | 0.6% Tinopal SCP | 0.25% CaCO₃ (0.7 micron) | 135.7 | 2.06 | 1.05 |

It can be seen from Table 1 that the addition of calcium phosphate alone to the coating solution did not yield improvements in print density, as was the case with calcium carbonate and calcium phosphate functionalized with poly(acrylic acid). Reduction of the amount of OBA in the coating solution results in decreased whiteness of the paper sheets.

Table 2 illustrates specific examples of the invention. In all examples, the coatings contained 0.6% Tinopal SCP as the OBA. Calcium phosphate-based particles were used to illustrate increases in print density without inducing a loss in sheet whiteness or substantial decrease in the a* value. The particles were prepared by both the batch and continuous flow methods.

TABLE 2

| | | Particle | | | | | | Print |
|---|---|---|---|---|---|---|---|---|
| Example | Treatment | Synthesis | Brightness | Whiteness | L* | a* | b* | Density |
| 22 | None (reference) | None | 104.0 | 130.0 | 96.4 | 2.02 | −8.77 | 1.14 |
| 6 | 0.25% | Continuous | 104.5 | 130.4 | 96.5 | 1.70 | −8.80 | 1.49 |
| | CaP:lys (1:0.5) | 6109-11 | | | | | | |
| 4 | 0.25% | Continuous | 104.5 | 130.5 | 96.5 | 1.71 | −8.85 | 1.47 |
| | CaP:lys (1:1) | 5900-173 | | | | | | |
| 19 | 0.25% | Continuous | 105.3 | 133.5 | 96.4 | 2.04 | −9.50 | 1.40 |
| | CaP:lys (1:2) | 5900-176 | | | | | | |
| 18 | 0.25% | Continuous | 103.8 | 129.8 | 96.4 | 2.08 | −8.75 | 1.42 |
| | CaP:betaine:lysine | 5900-175 | | | | | | |
| | (1.0:1.5:0.5) | | | | | | | |
| 13 | 0.25% | Batch | 104.8 | 131.3 | 96.5 | 1.80 | −9.01 | 1.45 |
| | CaP:lys(1:2) | 5900-113 | | | | | | |
| 17 | 0.25% | Batch | 105.0 | 131.6 | 96.6 | 1.77 | −9.07 | 1.39 |
| | CaP:aminoethyl | 5900-144 | | | | | | |
| | phosphate (1:2) | | | | | | | |
| 16 | 0.25% | Batch | 103.6 | 129.4 | 96.4 | 2.02 | −8.65 | 1.27 |
| | CaP:phosphocholine | 5900-133 | | | | | | |
| | (1:1) | | | | | | | |
| 22 | 0.125% lysine | 5996-137 | 104.3 | 130.8 | 96.4 | 1.99 | −8.97 | 1.05 |
| | hydrochloride | | | | | | | |

Table 2 illustrates that the addition of lysine alone to the surface treatment composition of the print media results in no appreciable increase in print density. The method by which the calcium phosphate-based particles are manufactured does not appear to impact the print density, nor does the ratio of Ca:S (i.e., calcium to surface charge or surface modifier) used in the manufacturing of the particles.

Table 3 demonstrates specific examples of the invention with color-pigmented inkjet inks. As above, the OBA used was 0.6% Tinopal SCP in the print media surface treatment composition. Print densities correspond to areas with 100% ink laydowns (Kodak 5100 AIO printer). A clear improvement can be seen in the print density of all colored pigment inks.

TABLE 3

| | | Print Density | | |
|---|---|---|---|---|
| Example | Treatment | Yellow print | Magenta print | Cyan print |
| 22 | None (reference) | 0.57 | 0.69 | 0.83 |
| 13 | 0.25% CaP:lys | 0.70 | 0.80 | 0.98 |
| | (1:2) batch | | | |
| | method) | | | |

Table 4 illustrates calcium phosphate-based particles can be combined with Extra White NW1 to yield a significant increase in sheet whiteness at reduced OBA dosages. In all examples, the OBA used in the print media surface treatment composition was Tinopal SCP. It can be seen that improved brightness and whiteness gains were associated with the particles of the invention. When the particles were combined with Extra White NW1, the brightness and whiteness increases were higher than with the particles alone. Combining the particles with Extra White NW1 allows for the OBA dosage to be decreased by half without a decrease in brightness or whiteness values when compared to the reference.

TABLE 4

| | OBA | | | | | | | Print |
|---|---|---|---|---|---|---|---|---|
| Example | Dose | Treatment | Brightness | Whiteness | L* | a* | b* | Density |
| 22 | 0.6% | None (reference) | 104.3 | 131.3 | 96.4 | 2.07 | −9.07 | 1.07 |
| 13 | 0.6% | 0.25% CaP:lys (1:2) | 105.3 | 132.6 | 96.5 | 1.82 | −9.33 | 1.41 |
| 13 | 0.6% | 0.25% CaP:lys(1:2) + 0.25% | 106.7 | 135.3 | 96.7 | 1.75 | −9.85 | 1.39 |
| | | Extra White NW1 | | | | | | |
| 13 | 0.3% | 0.25% CaP:lys(1:2 batch) + | 104.8 | 131.4 | 96.5 | 1.76 | −9.05 | 1.39 |
| | | 0.25% Extra White NW1 | | | | | | |

Table 5 illustrates calcium phosphate-based particles provide increases in print density while maintaining sheet brightness and whiteness. In all examples, the OBA used in the print media surface treatment composition was Tinopal ABP-A at a dose of 0.68%. It can be seen that for a given print density, paper sheets treated with a print media surface treatment composition containing the calcium phosphate-based particles of the invention had increased brightness and whiteness than a paper sheet treated with CaCl₂ (a common commercial offering).

TABLE 5

| | | | | | | | Print |
|---|---|---|---|---|---|---|---|
| Example | Treatment | Brightness | Whiteness | L* | a* | b* | Density |
| 22 | None (reference) | 107.2 | 141.9 | 95.8 | 1.08 | −11.7 | 1.00 |
| 22 | 0.75% CaCl2 | 105.1 | 127.2 | 96.5 | −2.17 | −8.1 | 1.47 |
| 1 | 0.25% CaP:lys(1:1) | 109.3 | 143.3 | 96.2 | −0.03 | −11.9 | 1.45 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible and should be interpreted as including the term “about.” Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combinations of some or all of the various embodiments described herein. Any and all patents, patent applications, scientific papers, and other references cited in this application, as well as any references cited therein, are hereby incorporated by reference in their entirety. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The claimed invention is:

1. A method of producing a print medium with enhanced whiteness and print quality, the method comprising: applying a surface treatment composition to one or more surfaces of a substrate, the surface treatment composition including a particle of a general formula of Cₓ(A)_{y}(OH)_{z}(SiO₂)ₖSₘ, wherein:
(a) C is a cation;
(b) A is an anion;
(c) S is a moiety that provides a surface charge and is selected from the group consisting of: surface modifiers, stabilizing agents, and combinations thereof;
(d) subscript x is from 1 to about 10;
(e) subscript y is from 1 to about 10;
(f) z is from 0 to about 20;
(g) k is from 0 to about 32; and
(h) m is from 0 to about 100.

2. The method of claim 1, wherein the cation is selected from the group consisting of alkali metals, alkaline earth metals, actinides, lanthanide metals, and any combination of the foregoing.

3. The method of claim 1, wherein the cation is selected from the group consisting of: calcium, magnesium, barium, zinc, and any combination of the foregoing.

4. The method of claim 1, wherein the anion is a salt selected from the group consisting of: phosphate, hydrogen phosphate, pyrophosphate, carbonate, and any combination of the foregoing.

5. The method of claim 1, wherein the general formula is Caₓ(PO₄)_{y}(OH)_{z}Sₘ.

6. The method of claim 5, further comprising wherein the particle has a characteristic selected from the group consisting of: a molar ratio of calcium to phosphate from about 1 to about 10; a surface area from about 5 m²/g to about 1,000 m²/g; pores ranging in size from about 5 Å to about 120 Å; a total pore volume from about 0.02 cc/g to about 1.0 cc/g; a particle size of about 5 nm to about 10 microns; and any combination of the foregoing.

7. The method of claim 1, wherein S is selected from the group consisting of: inorganic modifiers including at least one of the following aluminum, zirconium, titanium, zinc, cerium, boron, lithium, iron, and salts of the foregoing; polymeric surface modifiers include at least one of the following: polyamines, polyacrylates, polyethylene glycol, polyethylene oxide, polyethylene imines, poly quaternary amines, polyphosphonates, and polysulfonates; organic surface modifiers include at least one of the following: carboxylic acids, amines, phosphonates, organosilicones, organosilanes, glycols, nonionic surfactants, quaternary amines, amino acids; functional agents; markers; amines; thiols; epoxies; water-soluble agents; corrosion inhibitors; reaction products of the foregoing; and any combination of the foregoing.

8. The method of claim 1, wherein S is selected from the group consisting of: lysine, glycine, alanine, phosphinocholine, aminoethyl phosphate, any derivatives of the foregoing, and any combination of the foregoing.

9. The method of claim 1, wherein the print medium is selected from the group consisting of: printing paper, inkjet printing paper, laser jet paper, copy paper, bond, out sheet, envelope, photobase paper, inkjet photobase paper, and any combination of the foregoing.

10. The method of claim 1, wherein the substrate is formed from at least one material selected from the group consisting of: virgin pulp, recycled pulp, kraft pulp, sulfite pulp, mechanical pulp, polymeric plastic fibers, any combination of the foregoing pulps; recycled paper, paper tissue, dried paper substrates, and any paper or paper products made from the foregoing; and any combinations of the foregoing.

11. The method of claim 1, further comprising applying at least one optical brightening agent, either as part of the surface treatment composition or as a separate composition.

12. The method of claim 11, wherein the optical brightening agent is selected from the group consisting of: azoles, biphenyls, coumarins; furans; naphthalimides; pyrazenes; substituted stilbenes; salts of the foregoing, including alkali metal salts, alkaline earth metal salts, transition metal salts, organic salts, and ammonium salts; dilsulfonated, tetrasulfonated, or hexasulfonated stilbene derivatives; and any combination of the foregoing.

13. The method of claim 1, wherein the surface treatment composition further comprises at least one starch applied either simultaneously with or separately from the surface treatment composition.

14. The method of claim 13, wherein the starch is selected from the group consisting of: amylase, amylopectin, starches containing various amounts of amylose and amylopectin, corn starch, potato starch, enzymatically treated starches, hydrolyzed starches, heated starches, cationic starches, anionic starches, ampholytic starches, cellulose and cellulose derived compounds, and any combination of the foregoing.

15. The method of claim 1, wherein the surface treatment composition further comprises at least one sizing agent.

16. The method of claim 15, wherein the sizing agent includes at least one of the ingredients selected from the group consisting of: styrene acrylates, styrene acrylate maleic anhydride, and combinations thereof.

17. The method of claim 1, wherein the surface treatment further comprises a brightness-preserving and brightness-enhancing formulation comprising at least one penetrant, at least one reductive nucleophile, and/or at least one chelant applied either simultaneously with or separately from the calcium-based composition.

18. The method of claim 17, wherein the reductive nucleophile is selected from the group consisting of: sulfites; bisulfites; metabisulfites; sulfoxylates; thiosulfates; dithionites; polythionates; formamidinesulfinic acid and salts and derivatives thereof; aldehyde bisulfite adducts; sulfinamides and ethers of sulfinic acid; sulfenamides and ethers of sulfenic acid; sulfamides; phosphines; phosphonium salts; phosphites; thiophosphites; water-soluble inorganic sulfites; substituted phosphines and tertiary salts thereof; formamidine acid and salts thereof; formaldehyde bisulfite adducts; and any combination of the foregoing.

19. The method of claim 17, wherein the chelant is selected from the group consisting of: organic phosphonates phosphates, carboxylates, dithiocarbamates, salts of the foregoing, and any combination of the foregoing.

20. The method of claim 1, wherein the surface treatment composition further comprises at least one ingredient selected from the group consisting of poly vinyl alcohol, pigments, defoamers, lubricants, surfactants, dispersants, rheology modifiers, dyes, and any combination of the foregoing.

21. The method of claim 1, further comprising mixing the surface treatment composition with a surface sizing solution to form a mixture and applying the mixture to the one or more surfaces of the substrate in a size press.

22. A print medium prepared according to the method of claim 1.

23. The print medium of claim 22, further comprising an inkjet print medium.

24. The print medium of claim 22, further comprising an improved inkjet printing characteristic selected from the group consisting of: print density of a printed ink on the print medium; line growth of a printed ink on the print medium; bleed of a printed ink on the print medium; edge roughness of a printed ink on the print medium; mottle of a printed ink on the print medium; wicking of a printed ink on the print medium; show though of a printed ink through the print medium; and any combination of the foregoing.
